(19) United States
(12) Patent Application Publication
(10) Pub. No.: US 2016/0261645 A1
(43) Pub. Date: Sep. 8, 2016

(54) MOBILE APPLICATION LOCAL TIME ZONE SHIFTING

(71) Applicant: LeGuard, Inc., McLean, VA (US)

(72) Inventor: Anthony Clark LEWANDOWSKI, Herndon, VA (US)

(21) Appl. No.: 15/062,338

(22) Filed: Mar. 7, 2016

Related U.S. Application Data
(63) Continuation of application No. 62/129,295, filed on Mar. 6, 2015.

(51) Int. Cl. H04L 29/06; H04L 29/08

(52) U.S. Cl. CPC H04L 65/1066; H04L 67/16

(57) ABSTRACT

Systems, methods, and devices of the various embodiments enable a distributed activity reporting system, such as a billing system, with geographically separated computing devices operating in different local time zones to account for time differences between the different local time zones. In an embodiment, serialized objects transported between the computing devices in the distributed activity reporting system, such as a billing system, may include indications of the local time zone of the computing device originating the serialized object. In an embodiment, the indications of the local time zone of the computing device originating the serialized object may be used to shift the dates and times in the serialized object to the local time zone of the receiving computing device when the received object is de-serialized.

### RELATED APPLICATIONS

The present application claims priority to U.S. Provisional Patent Application No. 62/129,295 entitled “Mobile Application Local Time Zone Shifting” filed Mar. 6, 2015, the entire contents of which are hereby incorporated by reference.

### BACKGROUND

Distributed activity reporting systems, such as billing systems typically collect data, such as time entries, project information, costs, etc., from users and record the data in a central location. Such billing systems are used by professionals in many areas. Architects, consultants of all types, and lawyers, to name but a few, typically use such systems and report on a periodic basis (daily, monthly, weekly, quarterly, etc.) on the activities performed on behalf of a client.

For example, billing systems geared for use by a law firm will typically collect an amount of time an attorney works on a case and a description of what work was performed. The data collected from all users (attorneys, paralegals, and support staff) may be manipulated to provide a record of the time spent by individuals and/or an organization on a particular project matter or on work for a particular client. These systems thus provide an after-the-fact view of the amount of time spent on any particular matter

Managing time spent by workers in a geographically diverse and mobile workforce poses technical challenges. Work may be performed in a first time zone, and data about the work performed may be sent to a time and billing system in a different, second time zone. Worker mobility adds an additional potential challenge. For example, work may be performed in a first time zone, data about the work performed may be sent from a different, second time zone, and the receiving time and billing system may be located in a third time zone that is different from the first and second time zones. Accurate processing of data sets created and processed in different time zones is of vital importance to such enterprises.

### SUMMARY

The systems, methods, and devices of the various embodiments enable a distributed activity reporting system, such as a billing system, with geographically separated computing devices operating in different local time zones to account for time differences in data entries (objects) between the different local time zones. In an embodiment, objects transported between the computing devices in the distributed activity reporting system, such as a billing system, may include indications of the local time zone of the computing device originating the serialized object. In an embodiment, the indications of the local time zone of the computing device originating the object may be used to shift the dates and times in the serialized object to the local time zone of the receiving computing device when the received object is de-serialized.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2A is a component block diagram of a computing device according to an embodiment.

FIG. 2B is a component block diagram of a server according to an embodiment.

FIG. 3 is a process flow diagram illustrating an embodiment method for serializing objects for transport in a distributed activity reporting system.

FIG. 4 is a process flow diagram illustrating an embodiment method for de-serializing objects received in a distributed activity reporting system.

FIG. 5 is a component diagram of an example computing device suitable for use with the various embodiments.

FIG. 6 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” to refer to any one or all of cellular telephones, smart phones, personal or mobile multi-media players, personal data assistants (PDA's), laptop computers, tablet computers, desktop computers, smart books, palm-top computers, wireless electronic mail receivers, multimedia Internet enabled cellular telephones, wireless gaming controllers, and similar personal electronic devices which include a programmable processor and memory and circuitry for running a billing system application.

The various embodiments are described herein using the term “server.” The term “server” is used to refer to any computing device capable of functioning as a server, such as a master exchange server, web server, mail server, document server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device thereby enabling it to function as an Internet server (e.g., an enterprise e-mail server) only to the extent necessary to provide the functionality described herein.

In various embodiments, an application server may host a distributed activity reporting system, such as a billing system. Applications running on processors of computing devices, such as billing system applications running on processors of computing devices, may access the distributed activity reporting system and send objects to the distributed activity reporting system and/or request objects from the distributed activity reporting system. The applications may enable users to interact with the distributed activity reporting system remotely, and the central tracking of data by the distributed activity reporting system may enable the data entered by one user via his or her computing device running an application to be made available to a remote computing device, such as a server hosting a billing system or an application running a computing device of another user.

As used herein, the term “object” may be a grouping together of data and behavior packaged within an interaction specification called an interface. Objects may be mobile, meaning that the objects may be serialized (e.g., broken down into bits), transferred to a remote locations, and then de-serialized (e.g., reassembled from the bits) back into the objects

The various embodiments enable a distributed activity reporting system, such as a billing system, with geographically separated computing devices operating in different local time zones to account for differences in local time zones in data objects created in the computing devices. In an embodiment, objects are transported between the computing devices in the distributed activity reporting system, such as a billing system, may include indications of the local time zone of the computing device originating each object. In an embodiment, the indication of the local time zone may be a date-time offset object inserted into an object by a serialization/de-serialization module prior to serializing the object for transport. For example, the indication of the local time zone may be a value (e.g., plus or minus a number of minutes from coordinated universal time (UTC)) representing the time zone of the computing device.

In an embodiment, the indications of the local time zone of the computing device originating the object may be used to shift the dates and times in the serialized object to the local time zone of the receiving computing device when the received object is de-serialized. In an embodiment, the received object may be converted from a stream of bits to an object by a serialization/de-serialization module, and the date-time offset may be extracted from the object. The dates and times in the object may be shifted by the serialization/de-serialization module based on the difference between the time zone indicated by the extracted date-time offset and the device local time zone. For example, the difference between the value of the local time zone indicated in the extracted date-time offset (e.g., plus or minus a number of minutes from UTC) and the value of the device local time zone (e.g., plus or minus a number of minutes from UTC) may be used to shift the dates and times in the object to move the dates and times into the device local time zone. The date and time shifted object may then be provided to other modules, such as a user interface module of an application or a data management module of a server for further processing. In this manner, objects received by modules of an application or server may be provided in the local time zone of the device. This time shifting during de-serialization may reduce the complexity of the application and/or server modules because time conversions may not be required by the application and/or server modules since the dates and times of all objects provided from the serializing/de-serializing module may have been shifted to be in the same time zone. Additionally, the time shifting during de-serialization may speed up the processing of objects by the application and/or server modules because modules need not dedicate processing time and/or resources to converting or verifying time zones between objects.

The various embodiments are described using as examples billing system applications running on processors of computing devices and billing systems hosted by application servers. The discussions of billing system applications and billing systems are provided as an example embodiment to illustrate the aspects of the various embodiments, and are not intended to exclude other embodiments or limit the scope of the claims to billing system applications unless specifically recited in the claims. Other applications and systems may be used with the various embodiments, and the other applications and systems may be substituted in the various examples.

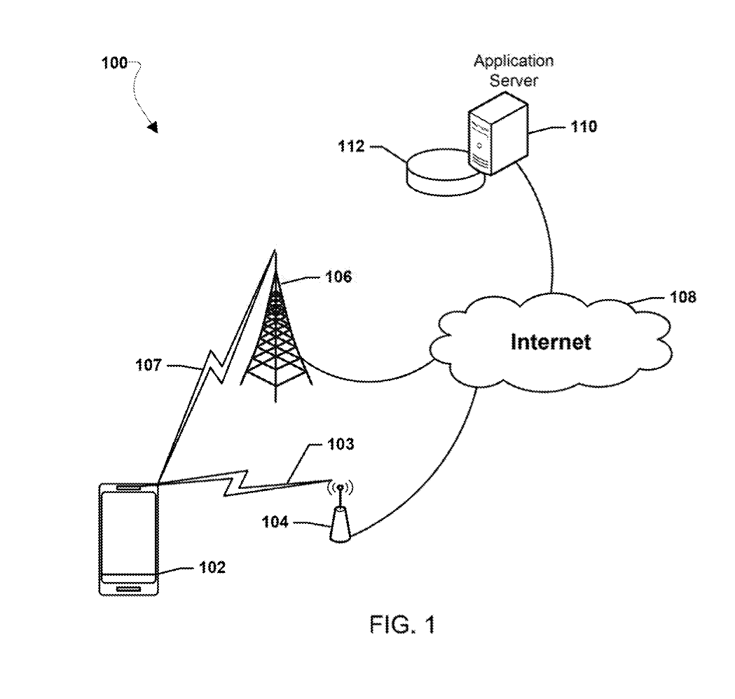

FIG. 1 illustrates a network system 100 suitable for use with the various embodiments. The network system 100 may include communication devices such as computing device 102, a base station 106, an access point 104, a communication network 108, and an application server 110. The base station 106 may communicate with the communication network 108 over a wired or wireless communication link, and the access point 104 may communicate with the communication network 108 over a wired or wireless communication link. The communication links to the communication network 108 may include fiber optic backhaul links, microwave backhaul links, and other communication links. In some embodiments, the communication network 108 may include the Internet and/or other networks such as a mobile telephony communication network. The computing device 102 may communicate with the base station 106 over a wired or wireless communication link 107. The computing device 102 may communicate with the access point 104 over a wired or wireless communication link 103. The communication links 103 and 107 may include wireless communication links that use one or more radio access technologies, such as examples of radio access technologies may include LTE, Worldwide Interoperability for Microwave Access (WiMAX), Code Division Multiple Access (CDMA), Time Division Multiple Access (TDMA), Wideband CDMA (WCDMA), GSM, a radio access protocol in the IEEE 802.11 family of protocols (e.g., Wi-Fi), and other radio access technologies. The communication links 107 and 103 may also include wired communication links using one or more wired communication protocols.

The communication network 108 may include a wired and/or wireless communication network, and may include processing nodes, routers, gateways, and physical and/or wireless data links for carrying data among various network elements, including combinations thereof, and can include a local area network, a wide area network, such as the Internet. The communication network 108 may carry data to support communications by the computing device. Wireless network protocols may include code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Worldwide Interoperability for Microwave Access (WiMAX), and Third Generation Partnership Project Long Term Evolution (3GPP LTE). Wired network protocols that may be utilized by the communication network 108 may include Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). The communication network 110 may also include a wireless network, including base stations, wireless communication nodes, telephony switches, internet routers, network gateways, computer systems, communication links, or some other type of communication equipment, and combinations thereof.

The application server 110 may be a network element in communication with the communication network 108 over a communication link, and may include a server processor and associated circuitry to execute or direct the execution of processor-executable or server-executable instructions to provide an application or service to the communication device 102. The application server 110 may communicate with storage such as a database 112 to store records and/or other data to provide the application or service. An example of the application/service may be a billing system application, which may be configured to track and process data sets of work performed by a geographically diverse and mobile workforce. The application server 110 may retrieve and execute software from storage, which may include a disk drive, flash drive, memory circuitry, or some other memory device, and which can be local or remotely accessible. The software may include computer programs, firmware, or some other form of machine-readable instructions, and may include an operating system, utilities, drivers, network interfaces, applications, or some other type of software, including combinations thereof The application server 110 may receive instructions and other input from a user interface. Examples of the application server 110 may include a standalone computing device, a computer system, or a network component, and can be accessible, for example, by a wired or wireless connection, or through an indirect connection such as through a computer network or communication network.

In an embodiment, computing device 102 and the application server 110 may be operating in different time zones. In an embodiment, the application server 110 may operate in UTC and the computing device 102 may operate in the time zone associated with its current geographic location.

In an embodiment, the computing device 102 and the application server 110 may exchange data with one another via the connections 103, 107 to the base station 106 and access point 104, respectively, and the various connections of the base station 106, access point 104, and application server 110 to the communication network 108. As an example, a processor of the computing device 102 running a billing system application may generate objects, such as time entries, project records, etc., and send the objects to the application server 110 via the Internet to update the records stored in the database 112. Additionally, the processor of the computing device 102 running the billing system application may request objects from the application server 110 and database 112 via the Internet. Objects may be sent, requested, received, and/or exchanged between the computing device 102 and application server 110 using the Hypertext Transfer Protocol or any other communication protocol.

When objects are sent between the computing device 102 and the application server 110, the objects may be serialized for transport by the sending device and de-serialized by the receiving device. Serializing an object may include operations to convert the object to be sent to a binary stream. De-serializing an object may include operations to convert a received binary stream to an object (e.g., a complex memory construct). Serialization and/or de-serialization may be performed by low level modules of applications and/or systems of running on the processors of the computing device 102 and/or the application server 110. Through the process of serialization and de-serialization by the respective sending device and respective receiving device, the computing device 102 and the application server 110 may exchange objects with one another.

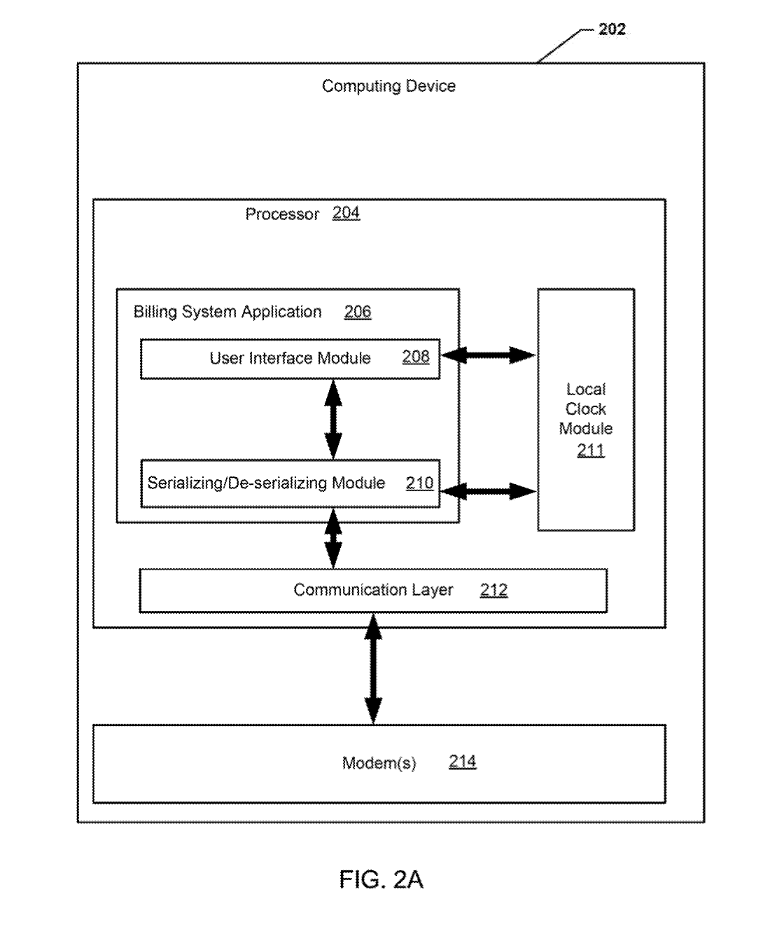

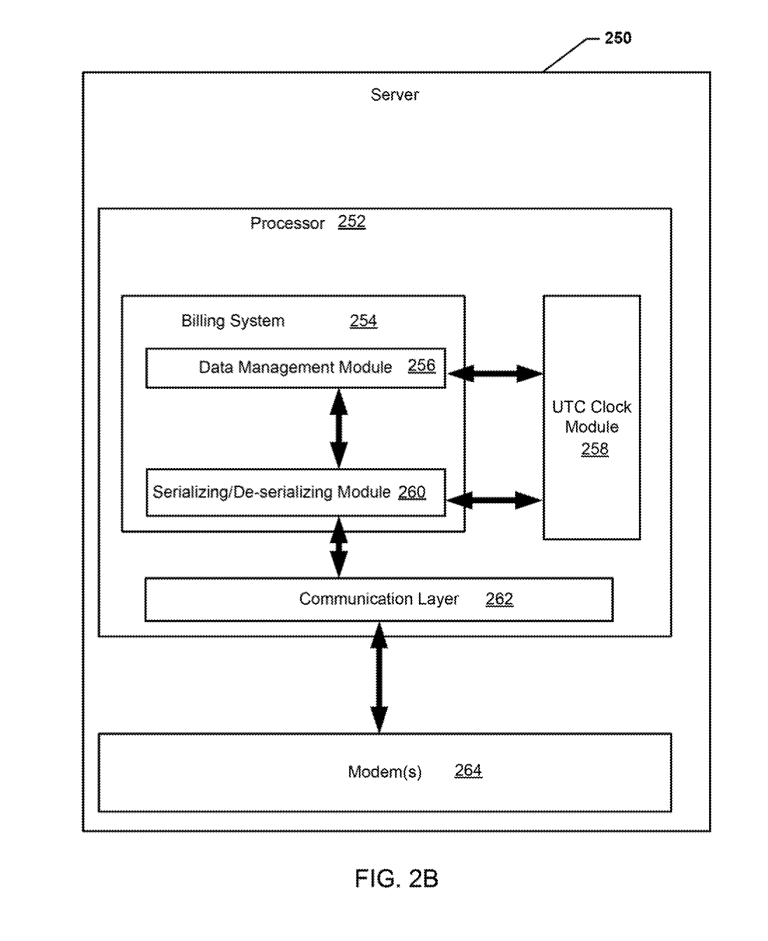

FIG. 2A is a component block diagram of a computing device 202 illustrating various components of the computing device 202 and modules of a billing system application 206 running on a processor 204 of the computing device 202 according to an embodiment. The computing device 202 may be similar to computing device 102 described above. For example, computing device 202 may be a smart phone.

The computing device 202 may include a modem 214 and other hardware, such as ports, antennas, etc., to establish wireless and/or wired connections with communications networks, such as communication network 108. The modem 214 may be connected to the processor 204 of the computing device 202 and the operations of the modem may be controlled by a communication layer 212 running on the processor 204. The communication layer 212 may receive data from applications running on the processor 204, such as the billing system application 206, and send the data to the modem 214 for transmission to remote devices, such as application server 110, via the wireless and/or wired connections with the communication networks, such as communication network 108. The modem 214 may also receive data via the wireless and/or wired connections with the communication networks, such as communication network 108, from remote devices, such as application server 110, and send the received data to the communication layer 212. The communication layer 212 may send data received from the modem to applications running on the processor 204, such as the billing system application 206. While FIG. 2A shows a single modem 214, the computing device 202 may include multiple modems, including different modems for supporting communications via different communication technologies (e.g., a wireless modem and a wired network interface modem, or a modem supporting each of two or more different wireless access technologies).

In an embodiment, the processor 204 of the computing device 202 may include a local clock module 211. The local clock module 211 may track the current local time zone the computing device 202 may be geographically located in and may provide the current date and time in the local time zone of the computing device 202 to other applications and modules running on the processor 204.

In an embodiment, the billing system application 206 may include one or more modules, such as a user interface module 208 and a serializing/de-serializing module 210. The user interface module 208 of the billing system application 206 running on the processor 204 of the computing device 202 may exchange data with a display of the computing device 202 and/or other input/output hardware of the computing device 202 to display information from the billing system application 206 to the user, such as forms, time entry records, log in screens, etc., and receive indications of user interactions with the billing system application 206, such as button press event indications, touchscreen item selection indications, etc. The user interface module 208 may generate and control the user-facing features of the billing system application 206, and based on user interactions with the billing system application 206, may generate objects to be sent to the application server 110 and/or generate requests for objects from the application server 110. The user interface module 210 may address the objects and/or requests for objects to the application server 110 hosting the billing system, such that the objects and/or request for objects may be sent via a communication network, such as the Internet, to the application server 110. The user interface module 208 may be a higher level module of the billing system application 206 and the objects created and/or requested by the user interface module 208 may be objects and the dates and times of these objects may be based on the date and time indicated to the user interface module by the local clock module 211 and may be in the local time zone of the computing device 202 as indicated by the local clock module 211.

In an embodiment, the user interface module 208 of the billing system application 206 running on the processor 204 of the computing device 202 may send the generated objects addressed for the application server 110 to the serializing/de-serializing module 210 of the billing system application 206 running on the processor 204 of the computing device 202. The serializing/de-serializing module 210 may serialize the objects it receives to create a binary stream may be sent to the communication layer 212. In an embodiment, the serializing/de-serializing module 210 may insert indications of the local time zone of the computing device 202 as indicated by the local clock module 211 into the objects before serialization. The serializing/de-serializing module 210 may also receive binary streams from the communication layer 212 and may de-serialize these streams to generate objects that may be sent to the user interface module 208. In an embodiment, the serializing/de-serializing module 210 may shift the dates and times in the objects to the local time zone of the computing device 202 after de-serialization but before the objects are sent to the user interface module.

FIG. 2B is a component block diagram of a server 250 illustrating various components of the server 250 and modules of a billing system 254 running on a processor 252 of the server 250 according to an embodiment. Server 250 may be similar to application server 110 described above.

The server 250 may include a modem 264 and other hardware, such as ports, antennas, etc., to establish wireless and/or wired connections with communications networks, such as communication network 108. The modem 264 may be connected to the processor 252 of the server 250 and the operations of the modem may be controlled by a communication layer 262 running on the processor 252. The communication layer 262 may receive data from applications or modules running on the processor 252, such as the billing system 254, and send the data to the modem 264 for transmission to remote devices, such as computing device 102, via the wireless and/or wired connections with the communication networks, such as communication network 108. The modem 264 may also receive data via the wireless and/or wired connections with the communication networks, such as communication network 108, from remote devices, such as computing device 102, and send the received data to the communication layer 262. The communication layer 262 may send data received from the modem to applications or modules running on the processor 252, such as the billing system 254. While FIG. 2B shows a single modem 264, the server 250 may include multiple modems, including different modems for supporting communications via different communication technologies (e.g., a wireless modem and a wired network interface modem, or a modem supporting each of two or more different wireless access technologies).

In an embodiment, the processor 252 of the server 250 may include a UTC clock module 258. The UTC clock module 258 may provide the current UTC date and time to other applications and modules running on the processor 252. In an embodiment, the UTC clock module 258 may also indicate the time zone of the server 250 as being UTC regardless of the actual geographic location of the server 250.

In an embodiment, the billing system 254 may include one or more modules, such as data management module 256 and a serializing/de-serializing module 260. The data management module 256 of the billing system 254 running on the processor 252 of the server 250 may exchange data with a database, such as database 112 to track, update, modify, delete, and otherwise process objects of the billing system 254. The data management module 256 may generate objects and/or retrieve objects from the database, such as database 112, to be sent to the computing device 102 in response to received requests for objects from the computing device 102. The data management module 256 may receive objects from the computing device 102 and/or generate objects and store them in the database, such as database 112. The data management module 256 may address the objects to the computing device 102, such that the objects may be sent via a communication network, such as the Internet, to the application computing device 102. The data management module 256 may be a higher level module of the billing system 254 and the objects created, received, retrieved, etc., by the data management module 256 may be objects and the dates and times of these complex objects may be based on the date and time indicated to the data management module 256 by the UTC clock module 258 and may be in UTC date and time.

In an embodiment, the data management module 256 may send objects addressed for the computing device 102 to the serializing/de-serializing module 260 of the billing system 254 running on the processor 252 of the server 250. The processor 252 executing the serializing/de-serializing module 260 may serialize the objects it receives to generate binary streams that may be sent to the communication layer 262. In an embodiment, the processor 252 executing the serializing/de-serializing module 260 may insert indications of the UTC date and time as indicated by the UTC clock module 258 into the objects before serialization. The processor 252 executing the serializing/de-serializing module 260 may also receive binary streams from the communication layer 262 and may de-serialize the binary streams to complex objects that may be sent to the data management module 256. In an embodiment, the processor 252 executing the serializing/de-serializing module 260 may shift the dates and times in the objects to UTC dates and times after de-serialization.

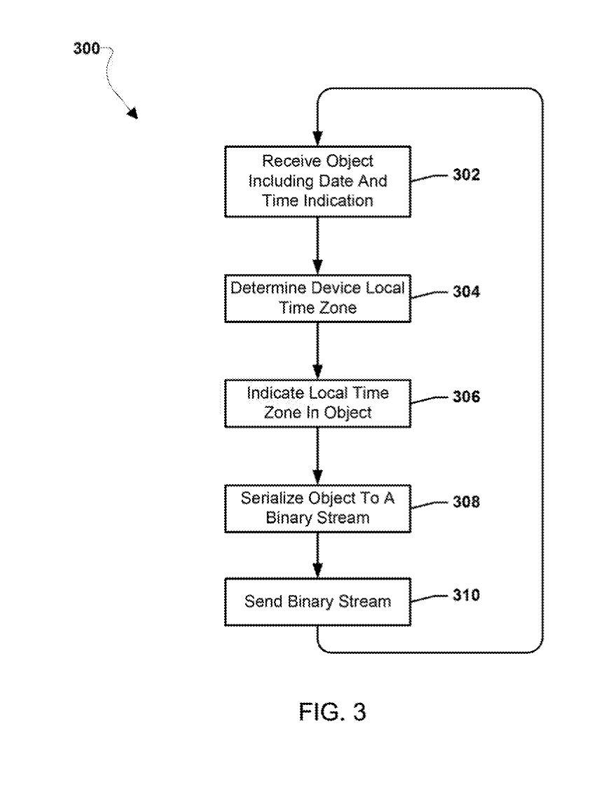

FIG. 3 illustrates an embodiment method 300 for serializing objects for transport in a distributed activity reporting system. The operations of the method 300 may be performed by a processor of a computing device, such as a processor of a smart phone or a server. For example, the operations of the method 300 may be performed by the processor 204 or 252 executing the serializing/de-serializing module 210 or 260 described above.

In block 302 the processor executing the serializing/de-serializing module may receive an object including a date and time indication. The object may be a memory construct representing a data element or record of a billing system, such as forms, time entry records, etc. The date and time indication may be the date and time in the local time zone of the device. The local time zone of the device may be the time zone associated with the current geographic location of a computing device or the local time zone may be UTC for a server. In block 304 the processor executing the serializing/de-serializing module running on the processor may determine the device local time zone. Determining the device local time zone may include requesting an indication of the current time zone of the device from a clock module running on the processor, such as clock modules 211 or 258 described above. For example, the indication of the local time zone may be determined as a value (e.g., plus or minus a number of minutes from UTC) provided by the clock module.

In block 306 the processor executing the serializing/de-serializing module running on the processor may indicate the local time zone in the object. In an embodiment, the processor executing the serializing/de-serializing module may indicate the local time zone by inserting a date-time offset into the object. For example, the indication of the local time zone may be a value (e.g., plus or minus a number of minutes from UTC). In block 308 the processor executing the serializing/de-serializing module may serialize the object to a binary stream, thereby converting the object for transport. In block 310 the processor executing the serializing/de-serializing module may send the binary stream to another device, such as another computing device and/or server. For example, the processor executing the serializing/de-serializing module may send the binary stream via a communication network to another device. The processor executing the serializing/de-serializing module may then return to block 302 and repeatedly perform the operations of the method 300 to serialize and send further objects.

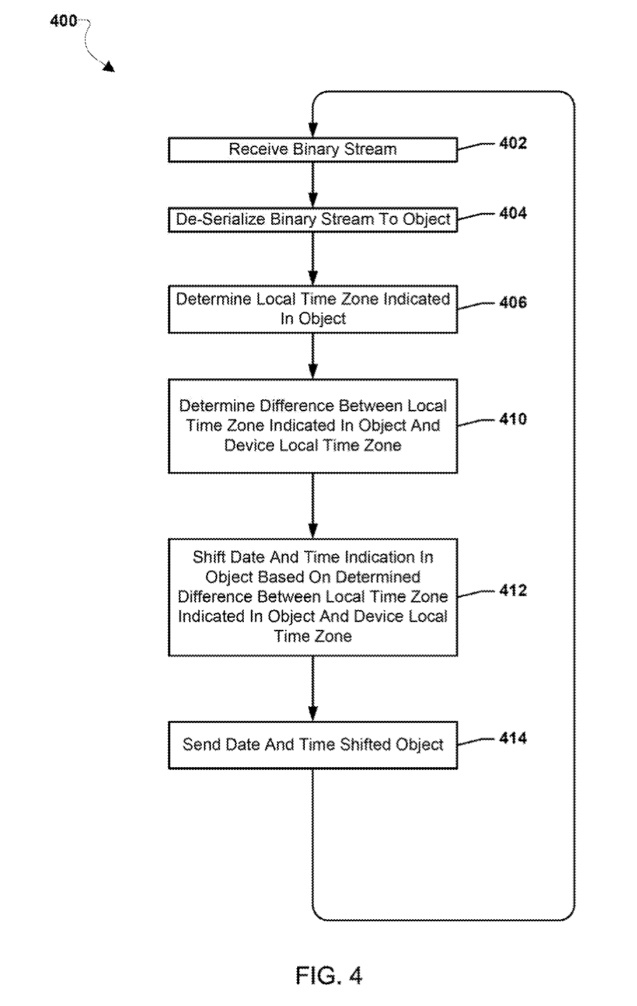

FIG. 4 illustrates an embodiment method 400 for de-serializing objects received in a distributed activity reporting system. The operations of the method 400 may be performed by a processor of a computing device, such as a processor of a smart phone or a server. For example, the operations of the method 400 may be performed by a serializing/de-serializing module 210 or 260 described above. The operations of the method 400 may be performed in conjunction with the operations of the method 300 described above.

In block 402 the processor executing the serializing/de-serializing module may receive a binary stream. In block 404 the processor executing the serializing/de-serializing module may de-serialize the binary stream to an object. This object contains the inserted date-time offset from UTC.

In block 406 the processor executing the serializing/de-serializing module may determine the local time zone indicated in the object. For example, the indication of the local time zone may be determined as a value (e.g., plus or minus a number of minutes from UTC). Determining the device local time zone may include requesting an indication of the current time zone of the device from a clock module running on the processor, such as clock modules 211 or 258 described above. For example, the indication of the device local time zone may be determined as a value (e.g., plus or minus a number of minutes from UTC) provided by the clock module.

In block 410 the processor executing the serializing/de-serializing module may determine a difference between the local time zone indicated in the object and the device local time zone. For example, the processor executing the serializing/de-serializing module may subtract the local time zone indicated in the object from the device local time zone to determine the difference between the local time zone indicated in the object and the device local time zone. In block 412 the processor executing the serializing/de-serializing module may shift the date and time indication in the object based on the determined difference between the local time zone indicated in the complex object and the device local time zone. For example, the difference between the value of the local time zone indicated in the date-time offset object (e.g., plus or minus a number of minutes from UTC) and the value of the device local time zone (e.g., plus or minus a number of minutes from UTC) may be used to shift the date and time in the object to move the dates and times into the device local time zone. In block 414 the processor executing the serializing/de-serializing module may send the date and time shifted complex object to other modules running on the device. The processor executing the serializing/de-serializing module may repeat the operations of method 400 to de-serialize more received transport objects in block 402.

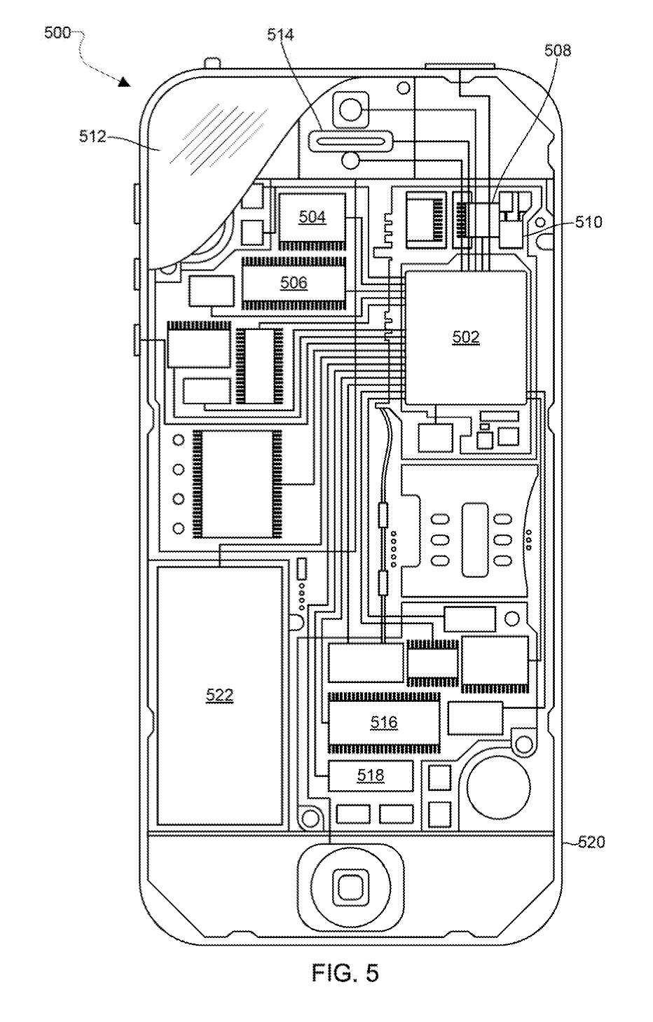

The various embodiments may be implemented in any of a variety of computing devices, an example of which is illustrated in FIG. 5. For example, the computing device 500 may include a processor 502 coupled to internal memories 504 and 506. Internal memories 504 and 506 may be volatile or non-volatile memories, and may also be secure and/or encrypted memories, or unsecure and/or unencrypted memories, or any combination thereof. The processor 502 may also be coupled to a touch screen display 512, such as a resistive-sensing touch screen, capacitive-sensing touch screen infrared sensing touch screen, or the like. Additionally, the display of the computing device 500 need not have touch screen capability. The computing device 500 may have one or more radio signal transceivers 508 (e.g., Peanut®, Bluetooth®, Zigbee®, Wi-Fi, RF radio) and antennae 510, for sending and receiving, coupled to each other and/or to the processor 502. The computing device 500 may include a cellular network interface, such as wireless modem chip 516, that enables communication via a cellular data network (e.g., CDMA, TDMA, GSM, PCS, 3G, 4G, LTE, or any other type of cellular data network) and is coupled to the processor 502. The receiver device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port. The computing device 500 may also include speakers 514 for providing audio outputs. The computing device 500 may also include a housing 520, constructed of a plastic, metal, or a combination of materials, for containing all or some of the components discussed herein. The computing device 500 may include a power source 522 coupled to the processor 502, such as a disposable or rechargeable battery. The rechargeable battery may also be coupled to the peripheral device connection port to receive a charging current from a source external to the computing device 500.

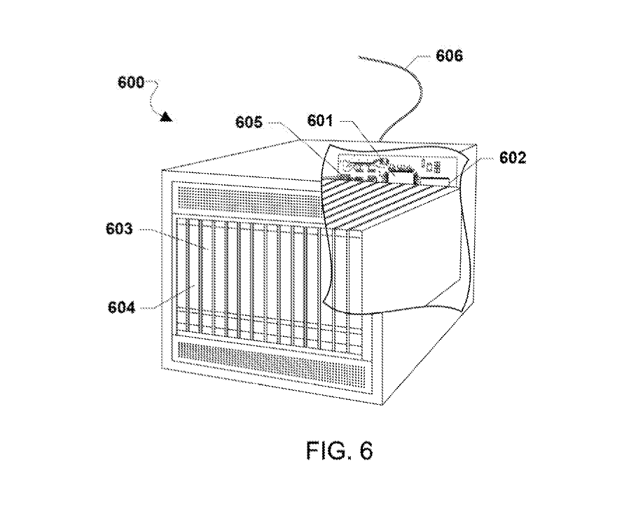

The various embodiments may also be implemented on any of a variety of commercially available server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive, compact disc (CD) or DVD disc drive 604 coupled to the processor 601. The server 600 may also include network access ports 606 coupled to the processor 601 for establishing network interface connections with a network 607, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 206, 254, 502, and 601 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 206, 254, 502, and 601. The processors 206, 254, 502, and 601 may include internal memory sufficient to store the application software instructions. In many devices the internal memory may be a volatile or nonvolatile memory, such as flash memory, or a mixture of both. For the purposes of this description, a general reference to memory refers to memory accessible by the processors 206, 254, 502, and 601 including internal memory or removable memory plugged into the device and memory within the processor 206, 254, 502, and 601 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, tiers, layers, circuits, and algorithm steps described in connection with the embodiments disclosed herein may be implemented as electronic hardware, computer software, or combinations of both. To clearly illustrate this interchangeability of hardware and software, various illustrative components, blocks, modules, tiers, layers, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for time zone shifting of objects during de-serialization, comprising:
receiving, by a first processor of a first device executing a first serializing/de-serializing module, a first object;
determining, by the first processor executing the first serializing/de-serializing module, a first device local time zone;
indicating, by the first processor executing the first serializing/de-serializing module, the first device local time zone in the first object;
serializing, by the first processor executing the first serializing/de-serializing module, the object including the first device local time zone indication into a binary stream; and
sending the binary stream to a second device.

2. The method of claim 1, further comprising:
receiving, by a second processor of the second device executing a second serializing/de-serializing module, the binary stream;
de-serializing, by the second processor executing the second serializing/de-serializing module, the binary stream to a second object;
determining, by the second processor executing the second serializing/de-serializing module, the first device local time zone indicated in the second object;
determining, by the second processor executing the second serializing/de-serializing module, a second device local time zone;
determining, by the second processor executing the second serializing/de-serializing module, a difference between the first device local time zone and the second device local time zone;
shifting, by the second processor executing the second serializing/de-serializing module, a date and time indication in the second object based on the difference between the first device local time zone and the second device local time zone; and
sending the date and time shifted second object from the second serializing/de-serializing module to another module running on the second processor of the second device.

3. The method of claim 2, wherein the first device is a computing device and the second device is a server.

4. The method of claim 3, wherein indicating, by the first processor executing the first serializing/de-serializing module, the first device local time zone in the first object comprises inserting, by the first processor executing the first serializing/de-serializing module, a date-time offset object including the first device local time zone in the first object.

5. A device, comprising:
a processor configured with processor executable instructions to perform operations comprising:
receiving a first object;
determining a first device local time zone;
indicating the first device local time zone in the first object;
serializing the object including the first device local time zone indication into a binary stream; and
sending the binary stream to an another device.

6. The device of claim 5, wherein the device is a computing device and the another device is a server.

7. The device of claim 6, wherein the processor is configured with processor executable instructions to perform operations such that indicating the first device local time zone in the first object comprises inserting a date-time offset object including the first device local time zone in the first object.

8. A system, comprising:
a first device comprising a first processor; and
a second device comprising a second processor,
wherein the first processor is configured with processor executable instructions to perform operations comprising:
receiving a first object;
determining a first device local time zone;
indicating the first device local time zone in the first object;
serializing the object including the first device local time zone indication into a binary stream; and
sending the binary stream to the second device.

9. The system of claim 8, wherein the second processor is configured with processor executable instructions to perform operations comprising:
receiving the binary stream;
de-serializing the binary stream to a second object;
determining the first device local time zone indicated in the second object;
determining a second device local time zone;
determining a difference between the first device local time zone and the second device local time zone;
shifting a date and time indication in the second object based on the difference between the first device local time zone and the second device local time zone; and
sending the date and time shifted second object from a serializing/de-serializing module to another module running on the second processor of the second device.

10. The system of claim 9, wherein the first device is a computing device and the second device is a server.

11. The system of claim 10, wherein the first processor is configured with processor executable instructions to perform operations such that indicating the first device local time zone in the first object comprises inserting a date-time offset object including the first device local time zone in the first object.
